(19) United States
(12) Patent Application Publication
(10) Pub. No.: US 2024/0422016 A1
(43) Pub. Date: Dec. 19, 2024

(54) PORTABLE POWER OVER ETHERNET INJECTOR

(71) Applicant: PROXEET LIMITED HE, Paphos (CY)

(72) Inventors: Aleksei KIZRIAKOV, Limassol (CY); Aleksandr ULYBIN, Limassol (CY); Evgenii PICHULIN, Limassol (CY); Andrey TIKHONOV, Pafos (CY)

(21) Appl. No.: 18/334,229

(22) Filed: Jun. 13, 2023

(51) Int. Cl. H04L 12/10

(52) U.S. Cl. CPC H04L 12/10

(57) ABSTRACT

The present disclosure relates generally to power sourcing equipment (PSE) for supplying electrical power together with data on Ethernet cabling to a remote powered device (PD), and, more particularly, to a portable PoE (Power over Ethernet) injector. A portable power over Ethernet (PoE) injector for transmitting electricity over Ethernet comprising:
a housing containing an RJ-45 input port for connecting a network device;
an RJ-45 output connector, which is connected to the housing and provide power to an external device;
wherein the POE injector connected to an external portable battery.

### TECHNICAL FIELD

The present disclosure relates generally to power sourcing equipment (PSE) for supplying electrical power together with data on Ethernet cabling to a remote powered device (PD), and, more particularly, to a portable PoE (Power over Ethernet) injector.

### BACKGROUND

Power over Ethernet (“PoE”) technology provides the method for transmitting electrical power via fixed devices, in particular, via PSE devices connected to AC electrical mains using an inverter and/or a transformer, which means that such a device is not portable and the possibility of its connection to the unpowered (not connected to electrical mains) networks is limited.

PoE technology describes any of several standards or special systems that transmit electrical power together with data via Ethernet cables over twisted pairs. This allows a single cable to ensure both data connection and sufficient power for devices such as wireless access points (WAPs), IP cameras, voice-over-IP (VOIP) phones, and other types of devices.

PoE technology is an important element in the overall functionality and stability of any modern commercial and residential network. A wide variety of PSE devices are also available on the market, although they all have a number of limitations. First of all, the most significant limitation of such devices is their poor mobility/portability. A PSE device requires a permanent connection to the alternating current (“AC”) power supply, a feature that significantly limits mobility and causes great discomfort to end users, making it impossible to operate such a PSE device in the areas without AC connection. As a rule, the concepts of mobility and AC are poorly combined with each other. AC is usually supplied through a convenience outlet. In this case, user's mobility is greatly limited by the length of an extension cord, which is usually 15-25 meters long. Otherwise, a 220 V sine wave must be formed but this requires a capacious battery with an inverter or an electric generator, which is already not a mobile/portable installation.

There are multiple prior art PSEs, which can power a PD by using both the existing IEEE (Institute of Electrical and Electronics Engineers) standards (e.g., IEEE 802.3af, IEEE 802.3at, IEEE 802.3bt), and IEEE incompatible standards, known as passive PoE. Such devices are used both as an end and intermediate option, for example, known from patent application U.S. 20150312048 A1. However, all existing devices are stationary and cannot be used outdoors without a permanent AC connection, e.g. at a construction site, on a roof.

Therefore, there is a need for a new technology that can solve the PSE mobility/portability problem.

### SUMMARY

The preferred embodiment of the proposed solution discloses a portable POE injector for transmitting electricity over Ethernet with a case that houses an RJ-45 input port for connecting a network device, an RJ-45 output connector is connected to the case to power an external device, while the injector allows to connect the device to an external portable battery.

One of the embodiments discloses the portable battery that is a removable power tool battery.

Another embodiment discloses the injector case housing a wire with a connector for connecting the portable battery.

Another embodiment discloses the injector case housing a terminal block that provides a mechanical connection to the battery.

Another embodiment discloses the injector case housing buttons for disconnecting the battery from that case.

Another embodiment discloses the injector further comprising a DC-DC converter.

Another embodiment discloses the injector further comprising a microcontroller.

Another embodiment discloses the microcontroller that is configured to monitor a network state.

### BRIEF DESCRIPTION OF DRAWINGS

FIG. 1 illustrates the connection of a wired POE injector to an external battery.

FIG. 2 illustrates the example of a POE injector with a mechanically connected external battery.

FIG. 3 illustrates the example of a POE injector with a DC-DC converter.

### DETAILED DESCRIPTION OF THE INVENTION

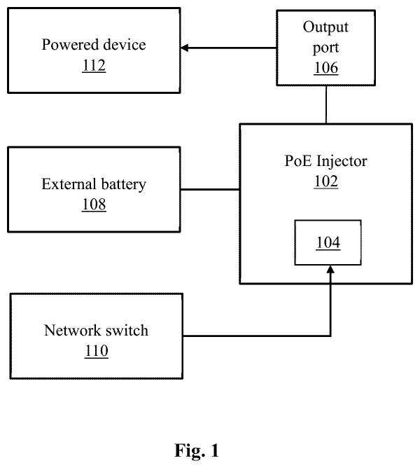

FIG. 1 depicts a general view of a portable POE injector 102 with a case that houses a port 104 for receiving data from a Non-PoE device, for example, a network switch 110, transmitted through an injector 102 to an output port 106, which can be embodied as an external port connected with the POE injector 102 via a wired connection. Ports 102 and 106 are RJ-45 twisted-pair ports. A PD 112 is connected to the output port 106, which receives data from the Non-PoE device 110 and power, which is supplied to the POE injector 102 from the connected external battery 108.

In this solution, a PD 112 can be represented by various devices that can be connected via a twisted pair, for example, IPTV cameras, VOIP devices, wireless access points, etc.

The external battery 108 in this solution is a removable battery from a power tool such as Bosch®, Makita®, DeWalt®, etc.

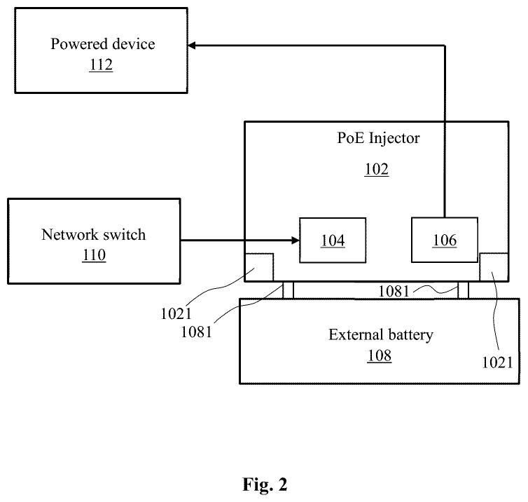

FIG. 2 depicts the embodiment of POE injector 102 with the case that houses the input port 104 and the output port 106. In addition, the connection to the external battery 108 is performed mechanically with the terminal block 1081. Since the external battery 108 is removable, the POE injector can 102 house the buttons 1021 to disconnect the battery 108 from the POE injector 102.

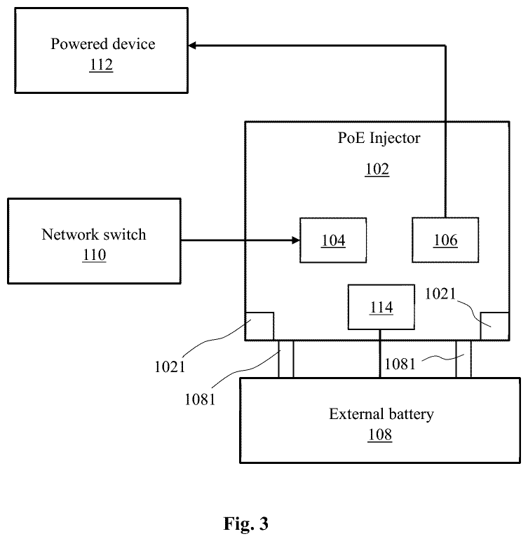

FIG. 3 depicts the embodiment of POE injector 102, in which the external battery 108 is connected via a DC-DC converter 114.

Additionally, the POE injector 102 may include a microcontroller, such as an IEEE 802.3 compatible microcontroller, that may provide for network status monitoring.

The claimed POE injector 102 may be applied in many ways. One of the embodiments of the POE injector 102 may be used by an engineer who mounts a wireless internet/network access point acting as a PD 112 (such as an outdoor Wi-Fi, or WiMAX, or GSM/LTE, or satellite subscriber module) on the roof of a building with no electrical outlets. Such an antenna can be connected before establishing a permanent connection to the power supply for obtaining the best signal.

Another embodiment of the portable POE injector 102 may not only help an engineer who initially designs and configures a network but also act as diagnostic equipment to detect a fault in the PoE link. Thus, if communication with the PD 112 is lost, the engineer can try to turn on the PD 112 on site, without dismantling it, and quickly determine the fault cause.

Another embodiment of the portable POE injector 102 may serve as an emergency power source for a PD 112 that is used in the critical infrastructure such as video surveillance.

1. A portable power over Ethernet (POE) injector for transmitting electricity over Ethernet, the POE injector comprising:
a housing containing an RJ-45 data input/output port for connecting a network device; and
an RJ-45 PoE output port, which is connected to the housing and provides power to an external powered device;
wherein the POE injector is connected to an external portable battery so as to provide the power.

2. The injector of claim 1, wherein the external portable battery is a removable power tool battery.

3. The injector of claim 2, wherein the external portable battery is connected to the housing using a set of contacts.

4. The injector of claim 2, wherein the housing further comprises a terminal block that provides a mechanical connection to the external portable battery that fixedly couples the external portable battery to the housing during use.

5. The injector of claim 4, wherein the housing has buttons for disconnecting the external portable battery from the housing.

6. The injector of claim 1, wherein the housing further comprises a DC-DC converter that converts voltage from the external portable battery for outputting to the external powered device.

7. The injector of claim 1, wherein the housing further comprises a microcontroller.

8. The injector of claim 7, wherein the microcontroller is configured to monitor a network state.

9. The injector of claim 7, wherein the microcontroller is an IEEE 802.3 compatible.

10. The injector of claim 1, wherein the injector performs diagnostics to detect a fault in the PoE link.
